(19) United States
(12) Patent Application Publication
(10) Pub. No.: US 2015/0350995 A1
(43) Pub. Date: Dec. 3, 2015

(54) NETWORK PRE-SELECTION FOR MOBILE TELEPHONY DEVICE

(71) Applicant: Vonage Network, LLC, Holmdel, NJ (US)

(72) Inventors: SAGI DUDAI, TEL AVIV (IL); BARUCH STERMAN, EFRAT (IL)

(73) Assignee: VONAGE NETWORK, LLC, HOLMDEL, NJ (US)

(21) Appl. No.: 14/291,539

(22) Filed: May 30, 2014

(51) Int. Cl. H04W 36/32; H04W 36/14; H04W 4/02

(52) U.S. Cl. CPC H04W 36/32; H04W 4/02; H04W 36/14

(57) ABSTRACT

Telephonic equipment comprises a pre-selection processor which is configured, upon receipt of an indication of actual or anticipated movement of a wireless telephony device, to pre-select a wireless network for wireless communication with the wireless telephony device for a predicted potential destination location of the movement. The pre-selection processor may be further configured to dynamically predict the potential destination location of the movement. The pre-selection processor may comprise telephonic equipment at an Internet telephony system or a wireless telephony device.

### TECHNICAL FIELD

The technology relates to telecommunications, and particular to Internet Protocol (IP) telephone systems that are accessible to mobile telephony devices.

### BACKGROUND

A telephone subscriber generally has one or more telephony devices which are served by a home carrier and which are associated with a nominal telephone number, such as a directory number. The directory number generally corresponds to an account for the subscriber. Telephonic communications emanating or originating from a telephony device of the subscriber as a calling party (e.g., outgoing communications) are generally routed by the calling party's home carrier through one or more switches, and possibly networks of other carriers, to a called party. The called party may be a subscriber of the same or of another home carrier. Conversely, telephonic communications destined for the telephony device of the called telephone subscriber (e.g., incoming communications) are routed on the basis of, e.g., the nominal telephone number, through switches to the called party's home carrier so that the communications may be “terminated” at the called party, i.e., the telephone subscriber.

In some instances in which the telephone device is an analogue device, the communications involving the telephone subscriber may be initiated as analogue communications and thereafter may be adapted for packet transmission. In other cases the telephony device may be a data packet-compatible device, such as an Internet Protocol (IP) device, so that the communication is essentially entirely packet-based. In either case, Internet Protocol telephony systems have been provided to route various types of communications, at least in part, via data packets that are communicated over a data network. The data network is commonly the Internet. The types of communications may be, for example, telephone calls, video calls, text and video messages, and other forms of telephony and data communications.

In some instances an outgoing communication may be routed at the subscriber's request to the Internet Protocol telephony system, so that the communications may be completed or “terminated” by the Internet Protocol telephony system. Conversely, many telephone providers provide a service such as “call forwarding” wherein an incoming communication to the nominal telephone number of the subscriber may be directed, at least temporarily, to another number where the subscriber would prefer to take the call. In this way using the “call forwarding” feature an incoming communication may be routed to another number which is associated with the Internet Protocol telephony system so that the incoming communication may be routed at least in part through the Internet Protocol telephony system en route to the subscriber.

Some users or subscribers of the IP telephony system may engage in communications using telephony devices that are connected by physical lines such as cables or wires to an access point such as an internet port. Such wired telephony devices may, thanks to the services of the IP telephony system, be moved from one physical location to another physical location, but at each such physical location are physically connected in wired manner to the respective access point.

Other users or subscribers of the IP telephony system may possess mobile or wireless telephony devices, such as a wireless terminal, user equipment (UE), mobile phone, smart phone, or laptop, tablet, or other device with mobile termination. When such a mobile telephony device is within coverage of an appropriate wireless access network (e.g., WiFi or WiMAX network) that has connection to the a data network such as the Internet, the communications involving the mobile telephony device may be handled by the IP telephony system in conjunction with the wireless access network. In other words, the communications may occur wirelessly between the mobile telephony device and a wireless access point of the wireless access network, with the wireless access point in turn being connected to an Internet portal. Typically the wireless connection of the mobile telephony device to the wireless access point is over unlicensed radio frequency resource(s). Access in this manner to the Internet portal enables the mobile telephony device to capitalize upon the service of the IP telephony system in economically routing the communications through the Internet, rather than over existing non-Internet service carriers, e.g., over a mobile radio access network.

When a mobile telephony device is not in range of a wireless access network and accordingly not able to gain the benefit of the IP telephony service, the mobile telephony device may instead be served by other carriers/services using one or more mobile radio access networks. Such mobile radio access networks typically comprise plural base stations which have both radio frequency transmitting and receiving capabilities to serve macro cells and typically use licensed frequency resource(s), such as GSM type mobile networks. A macro cell is essentially defined by the extent of the transmitting and receiving capabilities of the base station. The mobile telephony devices located within the cell may communicate with the radio access network through the base station (unless the customer also happens to be within range of another wireless network, such as a WiFi wireless network or the like, and exercises the option to use the other wireless network instead of the radio access network). In some instances such a “macro” base station may be called a “radio base station”, “base station”, NodeB, eNodeB, or the like.

A subscriber of an IP telephony service having a mobile telephony device, e.g., a wireless terminal, may be moving when making or receiving a communication, e.g., a call. For example, the subscriber may be normally at his or her desk in a cubicle environment, but upon receipt of an in-coming communication the subscriber may walk to a conference room or another part of a building to minimize disruption to others or for sake of privacy. Similar situations may occur at concerts, lectures, or sporting events, for example.

Generally the mobile telephony device is connected to a strongest wireless signal in the area at a given time. When the call is initially received through a first network, the signal may be good. But that same first network may not be optimal as the person with the telephony device moves around, whether to a conference room, or away from the concert hall, or to any other location.

What is needed, therefore, is an intelligent way to select a network that will improve quality of service during a communication, such as a voice-over-Internet (VoIP) call.

### SUMMARY

In one of its aspects the technology disclosed herein concerns telephonic equipment which comprises a pre-selection processor which is configured, upon receipt of an indication of actual or anticipated movement of a wireless telephony device, to pre-select a wireless network for wireless communication with the wireless telephony device for a predicted potential destination location of the movement.

In an exemplary embodiment and mode the pre-selection processor is configured to pre-select the wireless network by considering quality pre-selection criteria respecting plural candidate wireless networks for the pre-selected potential destination location. In an exemplary embodiment and mode, the pre-selection criteria comprises quality of service information respecting the plural candidate wireless networks for the predicted potential destination location.

In an exemplary embodiment and mode the pre-selection processor is further configured to dynamically predict the potential destination location of the movement based on historical activity of the wireless telephony device in respect to an origination location of the movement.

In an exemplary embodiment and mode the pre-selection processor is further configured to dynamically predict the potential destination location of the movement based on historical activity of at least one or more of other wireless telephony devices in respect to an origination location of the movement.

In an exemplary embodiment and mode the pre-selection processor is further configured to predict the potential destination location in accordance with a hard coded predetermined association with an origination location of the movement.

In an exemplary embodiment and mode the pre-selection processor comprises a telephony system with which the wireless telephony device communicates. In another exemplary embodiment and mode the pre-selection processor comprises the wireless telephony device.

In an exemplary embodiment and mode the pre-selection processor comprises an Internet-based telephony system.

In an exemplary embodiment and mode the pre-selection processor is further configured to receive negotiation information from the wireless telephony device to obtain the potential destination location.

In an exemplary embodiment and mode the pre-selection processor is further configured to request a user of the wireless telephony device for an explicit indication of the potential destination location.

In an exemplary embodiment and mode the pre-selection processor is further configured to request a user of the wireless telephony device to mark a path or the potential destination location on a map displayed on the wireless telephony device.

In an exemplary embodiment and mode the pre-selection processor is further configured to request a user of the wireless telephony device to select the potential destination location from a plurality of location options displayed on the wireless telephony device.

In another of its aspects the technology disclosed herein concerns a wireless telephony device comprising a processor. The processor is configured to provide an indication of actual or anticipated movement of the wireless telephony device to a telephony network and to receive from the telephony network an indication of a suggested pre-selected wireless network for the wireless telephony device to access for wireless communications at a predicted potential destination location of the movement.

In an exemplary embodiment and mode the processor is further configured to send to the telephony network an origination location and an actual destination location associated with the movement.

In an exemplary embodiment and mode the processor is configured to pre-select the wireless network by considering pre-selection criteria for the predicted potential destination location respecting plural candidate wireless networks. In an exemplary embodiment and mode, the pre-selection criteria comprises quality of service information respecting the plural candidate wireless networks for the predicted potential destination location.

In an exemplary embodiment and mode the processor is configured to receive quality of service information reports for the predicted potential destination location respecting plural candidate wireless networks as gathered by plural reporting wireless telephony devices.

In an exemplary embodiment and mode the processor is further configured to predict the potential destination location of the movement.

In an exemplary embodiment and mode wherein the processor is further configured to dynamically predict the potential destination location of the movement based on historical activity of the wireless telephony device in respect to an origination location of the movement.

In an exemplary embodiment and mode the processor is further configured to dynamically predict the potential destination location of the movement based on historical activity of at least one or more of other wireless telephony devices in respect to an origination location of the movement.

In an exemplary embodiment and mode the processor is further configured to predict the potential destination location in accordance with a hard coded predetermined association with an origination location of the movement.

In an exemplary embodiment and mode the processor is further configured to request a user of the wireless telephony device for an explicit indication of the potential destination location.

In an exemplary embodiment and mode the processor is further configured to request a user of the wireless telephony device to mark a path or the potential destination location on a map displayed on the wireless telephony device.

In an exemplary embodiment and mode the processor is further configured to request a user of the wireless telephony device to select the potential destination location from a plurality of location options displayed on the wireless telephony device.

In another of its aspects the technology disclosed herein concerns a method in a communications network. In a basic mode the method comprises obtaining an indication of actual or anticipated movement of a wireless telephony device. Upon receipt of the indication of the actual or the anticipated movement, the method further comprises pre-selecting a wireless network for wireless communication with the wireless telephony device for a predicted potential destination location of the movement.

In an exemplary embodiment and mode the method further comprises (1) the wireless telephony device providing the indication of actual or anticipated movement of the wireless telephony device to a telephony system; (2) the telephony system pre-selecting the wireless network for the wireless communication with the wireless telephony device for the predicted potential destination location of the movement; and (3) the wireless telephony device receiving from the telephony network an indication of the pre-selected wireless network for the wireless telephony device to access for wireless communications for the predicted potential destination location.

In an exemplary embodiment and mode the method further comprises the wireless telephony device pre-selecting the wireless network for the wireless communication with the wireless telephony device for the predicted potential destination location of the movement.

In an exemplary embodiment and mode the method further comprises pre-selecting the wireless network by considering pre-selection criteria for the predicted potential destination location respecting plural candidate wireless networks. In an exemplary embodiment and mode, the pre-selection criteria comprises quality of service information respecting the plural candidate wireless networks for the predicted potential destination location.

In an exemplary embodiment and mode the method further comprises receiving quality of service information reports for the predicted potential destination location respecting plural candidate wireless networks from plural reporting wireless telephony devices.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of an exemplary communications network in which verification of a call forwarding operation may be performed.

FIG. 2A is a flowchart illustrating basic, representative acts or steps performed by telephonic equipment according to an exemplary embodiment and mode.

FIG. 2B is a flowchart illustrating basic, representative acts or steps performed by telephonic equipment according to an exemplary embodiment and mode.

FIG. 3 is a diagrammatic view showing a situation in which a telephony device is served by a wireless network but is beginning to move, and for which network pre-selection may be appropriate.

FIG. 4 is a flowchart illustrating basic, representative acts or steps performed by a network pre-selection processor according to an exemplary embodiment and mode when an IP telephony system serves as network pre-selecting telephony equipment.

FIG. 5 is a diagrammatic view showing various exemplary processes performed by a network pre-selection processor according to an exemplary embodiment and mode.

FIG. 6 is a schematic view of non-limiting, non-exhaustive functionalities and units comprising a network pre-selection processor as implemented in a telephony system according to an exemplary embodiment and mode.

FIG. 7 is a flowchart illustrating basic, representative acts or steps performed by a network pre-selection unit according to an exemplary embodiment and mode when an IP telephony system serves as network pre-selecting telephony equipment.

FIG. 8 is a diagrammatic view showing various exemplary processes performed by a network pre-selection unit of a wireless telephony device according to an exemplary embodiment and mode.

FIG. 9 is a schematic view of non-limiting, non-exhaustive functionalities and units comprising a wireless telephony device according to an exemplary embodiment and mode.

FIG. 10A and FIG. 10B are signaling diagrams illustrating various signals and/or messages transmitted between an IP telephony system and a wireless telephony device in conjunction with a network pre-selection procedure which is performed by cooperative execution of a network pre-selection processor and a network pre-selection unit according to an exemplary embodiment and mode.

FIG. 11A-FIG. 11E show basic example acts or steps performed by execution of various processes of a network pre-selection processor according to an exemplary embodiment and mode.

FIG. 12A-FIG. 12D show basic example acts or steps performed by execution of various processes of a network pre-selection unit according to an exemplary embodiment and mode.

FIG. 13A and FIG. 13B are diagrammatic views showing exemplary map database records in a map database according to differing exemplary embodiments and modes.

FIG. 14 is a diagrammatic view showing exemplary trip database records in a trip database.

FIG. 15A and FIG. 15B are diagrammatic views showing differing exemplary embodiment and modes of how a network pre-selection unit may prompt or request a user of a wireless telephony device for an explicit indication of a potential destination location.

FIG. 16 is a schematic view of non-limiting, non-exhaustive functionalities and units comprising a wireless telephony device according to another exemplary embodiment and mode.

FIG. 17 is a schematic view of non-limiting, non-exhaustive functionalities and units comprising a network pre-selection processor as implemented in a telephony system according to an exemplary embodiment and mode.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

In the following description, the terms “VoIP system,” “VoIP telephony system,” “IP system” and “IP telephony system” are all intended to refer to a system that connects callers and that delivers data, text and video communications using Internet protocol data communications.

The following description will refer to “telephony communications.” The term “telephony communications” is intended to encompass any type of communication that could pass back and forth between users of an IP telephony system. This includes audio and video telephone, text messages, video messages and any other form of telephony or data communication.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an Apple iPhone™, a RIM Blackberry or a comparable device running Google's Android operating system could be a mobile telephony device.

In still other instances, a mobile telephony device may be a device that is not traditionally used as a telephony device, but which includes a wireless data transceiver that can establish a wireless data connection to a data network. Examples of such devices include the Apple iPod Touch™ and the iPad™. Such a device may act as a mobile telephony device once it is configured with appropriate application software.

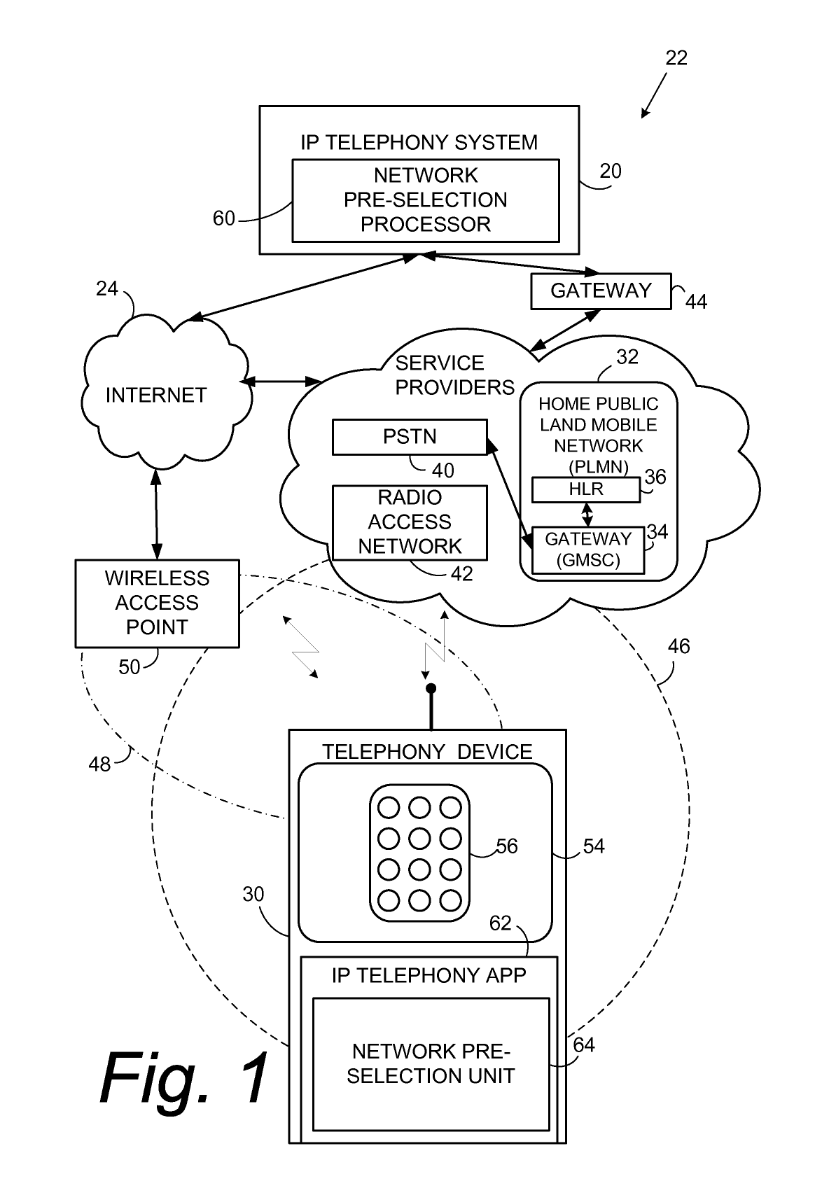

FIG. 1 shows an exemplary telephony system 20, in context of an exemplary generic communications system 22. In view of the fact that the telephony system 20 may be an Internet (IP) telephony service, the telephony system 20 is shown as connected to a data communications network such as Internet 24 and is herein sometimes referred to as an “internet-based” telephony system 20. An example of such an Internet-based telephony system 20 is a voice over IP (VoIP) telephony system. However, in view of the fact that the communications encompassed by the technology described herein is not limited to voice communications, the internet-based telephony system 20 may also be referred to as a “Communication over IP”, or “CoIP system”.

A telephony device 30 is associated with a customer of the telephony system 20. The telephony device 30 happens to be a mobile or wireless telephony device such as a user equipment unit, smart phone, electronic tablet, or laptop with mobile termination, for example. The wireless telephony device 30 may be used by an individual who has, or is a member of a group which has, an account or subscription with IP telephony system 20.

The customer associated with telephony device 30 is not only a customer of IP telephony system 20, but is also served by the customer's home public land mobile network 32, also known as the “home carrier”. The customer's home public land mobile network 32 is shown in FIG. 1 as comprising PLMN gateway or switching center (GMSC) 34, as well as a PLMN home location register (HLR) 36. The home public land mobile network 32 may be connected to or actually comprise the public switched telephone network (PSTN) 40. The home public land mobile network 32 is connected to public switched telephone network (PSTN) 40 through the PLMN gateway 34. The public switched telephone network (PSTN) 40 may be connected to or comprise one or more radio access network(s) (RANs) 42. The telephony system 20 is also connected to public switched telephone network (PSTN) 40 through one or more gateway(s) 44.

The radio access network(s) (RANs) 42 typically comprise one or more base stations which transmit and receive communications over radio frequencies for serving wireless terminals situated in macro cells defined by the respective coverage of the respective base stations. One such example, representative macro cell 46, is shown by dashed lines in FIG. 1 as covering, e.g., a location in which wireless telephony device 30 resides, and thereby supplying radio access to wireless telephony device 30 as wireless telephony device 30 may request or require. Typically macro base stations of the radio access networks 42 communicate with mobile terminals in their respective macro cells 46 using licensed radio frequency resource(s). The radio access network(s) (RANs) 42 include those such as Global System for Mobile Communications (GSM), Universal Terrestrial Radio Access Network (UTRAN), and Long Term Evolution (LTE), or any other network technologies such as GSM/EDGE and UMTS/HSPA.

FIG. 1 also shows, by dashed-dotted line, a smaller cell 48 which is served by wireless access point 50. FIG. 1 shows wireless telephony device 30 as being within the smaller cell 48, which may be, e.g., a micro cell, pico cell, or femto cell. The wireless access point 50 may serve the wireless telephony device 30 using technologies such as Wi-Fi or WiMAX. Wi-Fi is a technology that allows an electronic device to exchange data or connect to the internet wirelessly using microwaves in the 2.4 GHz and 5 GHz bands, and thus includes any wireless local area network (WLAN) products that are based on the Institute of Electrical and Electronics Engineers' (IEEE) 802.11 standards. Typically such wireless access points 50 communicate with wireless devices within their cells 48 by using unlicensed radio frequency resource(s).

As apparent from the foregoing, telephony device 30 may be essentially any type of electronic device with telephony capabilities. The telephony device 30 may be a mobile telephony device, or may be fixed (e.g., stationary) electronic computer such as a desktop computer with telephony capabilities. In whatever form of equipment it takes, telephony device 30 comprises user input and output interfaces. In some instances the input and output interfaces may comprise a traditional keyboard and display, such as an LCD display, for example. Another example input/output device is input/output touchscreen/display screen 54 illustrated in FIG. 1. At various times the input/output touchscreen/display screen 54 may display or otherwise depict keyboard or keypad 56. Depending on the type of equipment in which telephony device 30 is subsumed, the keypad/keyboard 56 may take one or more various forms, such as that of a QWERTY keyboard or a telephone type keypad. At other times the input/output touchscreen/display screen 54 may depict various other menus or displays, at least some of which may invite or prompt user interaction. Such interaction may be manual or stylus impulse (e.g., touch or contact with capacitive recognition/sensing), or even voice input. It should be understood that other input and output devices are also included, such as microphone and speakers.

The technology disclosed herein concerns, e.g., methods, apparatus (either or both in an IP telephony system and in a wireless telephony device), and techniques for pre-selecting a wireless network for the telephony device 30 to access for transmission of wireless communications when there has been an indication that the telephony device 30 anticipates movement (e.g., a “move”) or actually is moving. In an exemplary basic aspect the technology disclosed herein concerns telephonic equipment comprising a processor which, upon receipt of an indication of actual or anticipated movement of a wireless telephony device, pre-selects a wireless network for wireless communication with the wireless telephony device for a pre-selected or predicted potential destination location of the movement. The phrase “destination location” comprises at least one or more of the destination location itself and one or more locations along a path toward the destination location, and thus encompasses any indication of destination location, any indication of path, as well as direction of movement.

In some example embodiments and modes such telephonic equipment may be a processor of the telephony system 20. To that end, FIG. 1 shows IP telephony system 20 as comprising network pre-selection processor 60, and wireless telephony device 30 as comprising IP telephony application (app) 62 which includes network pre-selection unit or agent 64. In other embodiments, such telephonic equipment may be a processor of the telephony device 30, e.g., may be a processor which implements or executes the network pre-selection unit 64.

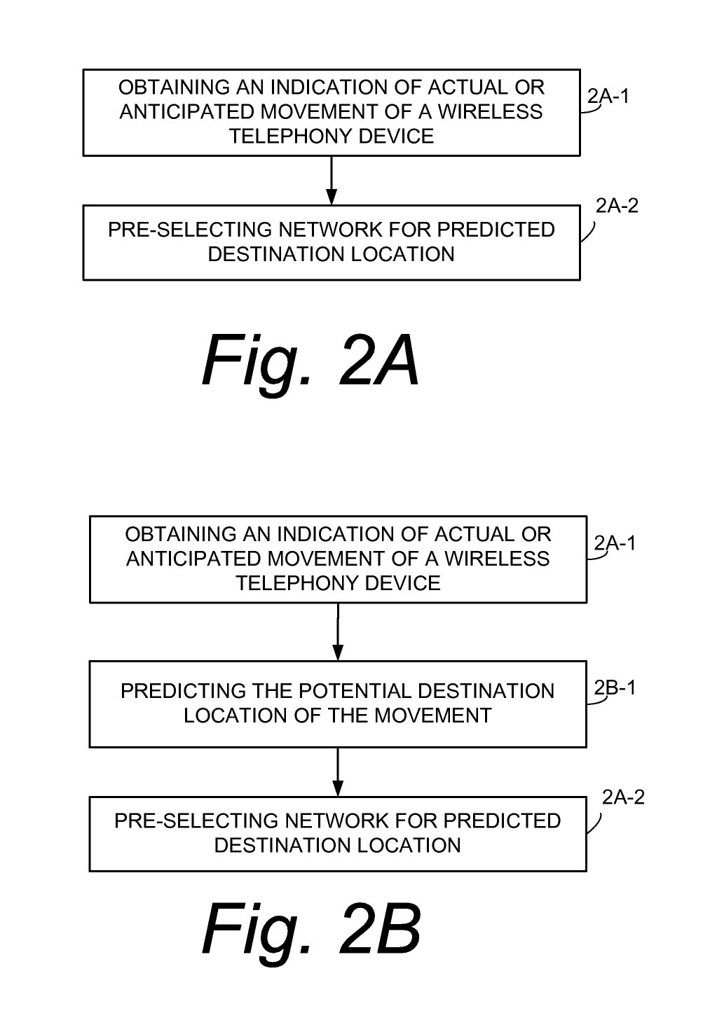

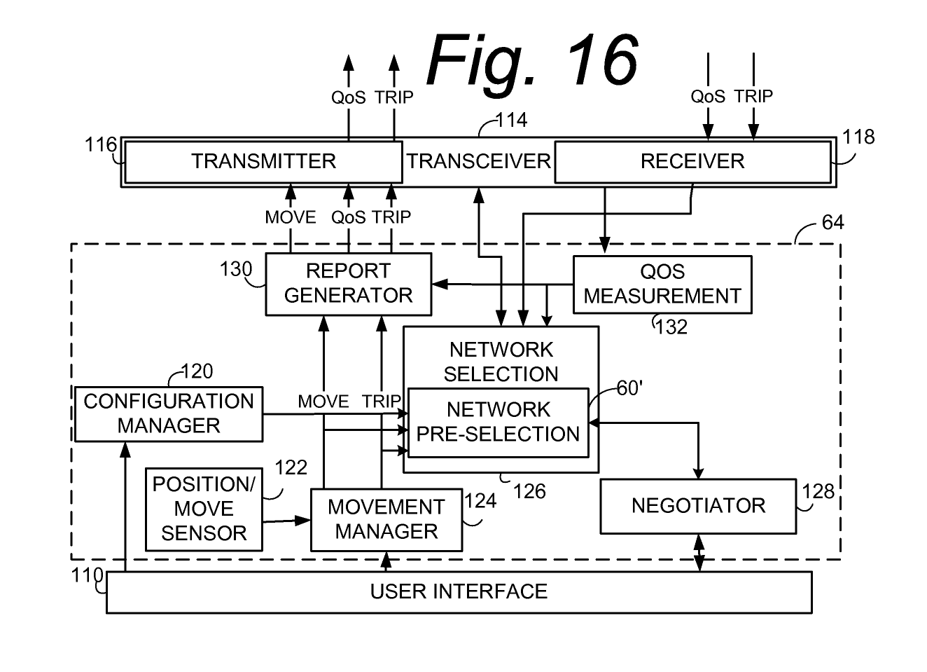

FIG. 2A illustrates basic, representative acts or steps performed by telephonic equipment of the technology disclosed herein according to an exemplary embodiment and mode. In differing embodiments, the acts of FIG. 2A may be preformed by telephony system 20 (e.g., network pre-selection processor 60 of telephony system 20 as shown in FIG. 6) or by telephony device 30 (e.g., by network pre-selection processor 60′ of telephony device 30 as shown in FIG. 16).

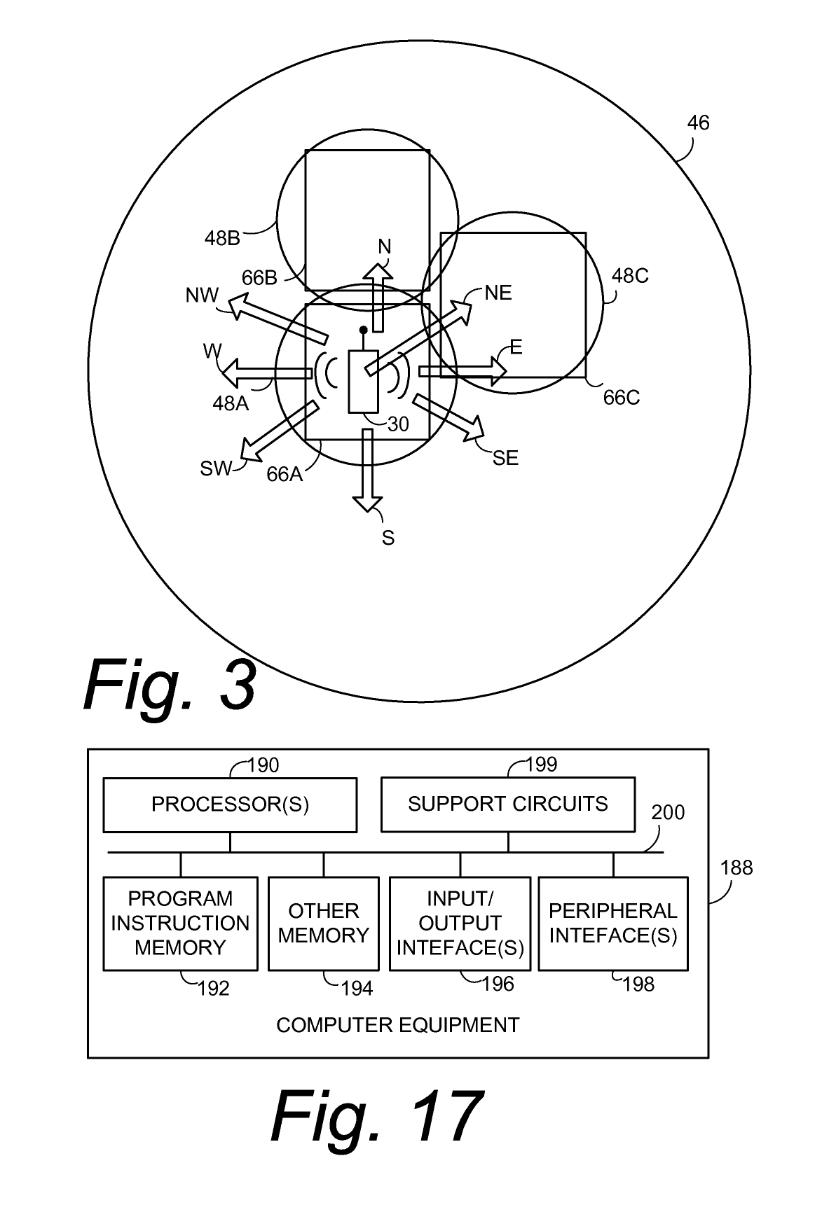

The acts of FIG. 2A may be better appreciated in context of an example situation shown in FIG. 3. FIG. 3 shows telephony device 30 positioned in a location such as building 66A, which is served by access point cell 48A. At the time shown in FIG. 3 the telephony device 30 beings to move. At early movement it is not yet known in which direction the telephony device 30 will move. For sake of discussion, the telephony device 30 could potentially move in any one of eight directions as shown by corresponding arrow in FIG. 3: an east direction (E); a northeast direction (NE); a north direction (N); a northwest direction (NW); a west direction (W); a southwest direction (SW); a south direction (S); or a southeast direction (SE). It so happens in the situation of FIG. 2 that for travel in the north direction to building 66B the telephony device 30 may have access to access point cell 48B; that for travel in either the east or northeast direction to building 66C the telephony device 30 may have access to access point cell 48C; but that for travel in another other direction the telephony device 30 may have to gain wireless access through macro cell 46.

Act 2A-1 comprises obtaining an indication of actual or anticipated movement of wireless telephony device 30. As explained herein, the indication of movement may be actual sensed movement of telephony device 30, or input received from the user of telephony device 30 indicating that the user intends to move. Upon receipt of the indication of the actual or the anticipated movement, act 2A-2 is preformed. Act 2A-2 comprises pre-selecting a wireless network for wireless communications with telephony device 30 for a pre-selected or predicted potential destination location. In other words, act 2A-2 comprises pre-determining which network (e.g., the network of access point cell 48B, the network of access point cell 48C, or the network of macro cell 46) should next service the wireless communications of telephony device 30.

FIG. 2B illustrates another exemplary embodiment and mode of a method which resembles FIG. 2A. FIG. 2B includes the further basic act 2B-1 performed by telephonic equipment of the technology disclosed herein according to an exemplary embodiment and mode. Act 2B-1 comprises selecting the pre-selected potential destination location of the movement, e.g., predicting the destination location.

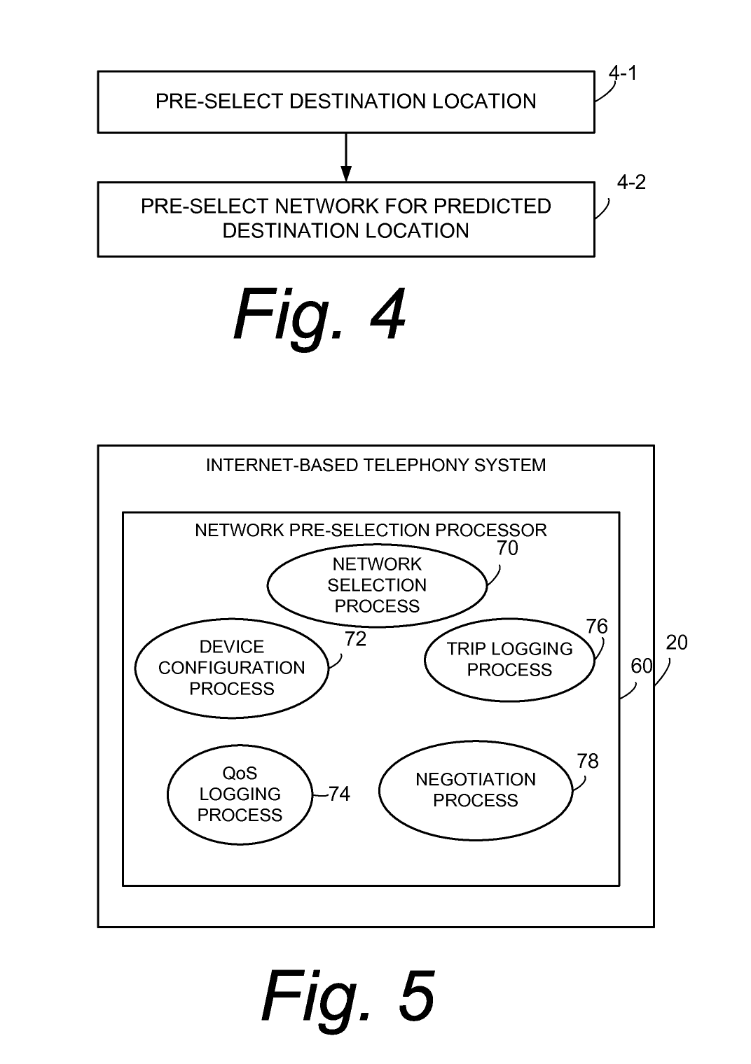

FIG. 4 shows various example basic acts or steps performed by network pre-selection processor 60 of FIG. 6 or the network pre-selection processor 60′ of FIG. 16 according to an exemplary embodiment and mode. Act 4-1 comprises the network pre-selection processor 60/60′ pre-selecting or predicting a destination location. Act 4-2 comprises the network pre-selection processor 60/60′ pre-selecting a network for the pre-selected or predicted destination location of movement. In performing these acts, the network pre-selection processor 60/60′ may execute various processes such as those shown by way of example in FIG. 5. As shown in FIG. 5, example processes performed by network pre-selection processor 60/60′ include network selection process 70, which in turn uses information acquired through device configuration process 72; quality of service (QoS) logging process 74; trip logging process 76; and negotiation process 78. In an exemplary embodiment and mode an instance these processes may be executed for each wireless telephony device for which network pre-selection processor is currently involved in a network pre-selection procedure.

A non-limiting, non-exhaustive exemplary embodiment of network pre-selection processor 60 is shown in FIG. 6. Although termed a “processor”, it should be understood that network pre-selection processor 60 is not limited to a single central processing unit (CPU), but instead may compass plural processors, either shared or distributed, along with auxiliary computer-implemented components. With such understanding, network pre-selection processor 60 of FIG. 6 is shown as comprising processing units 80; interface units 82; and databases 84. The interface units 82 include report interface 82R; configuration interface 82C; and pre-selection interface 82P. The databases 84 include map database 84M; device database 84D; trip database 84T; and coded database 84C. The processing units 80 include map database manager 80M; device database manager 80D; trip database manager 80T; network pre-selector 86; and destination pre-selector 88. One or more of the processing units 80, and particularly network pre-selector 86 and destination pre-selector 88, may constitute a “pre-selection processor”. It should be appreciated that the functionalities shown for each of processing units 80, interface units 82, and databases 84 may be separate functionalities or units as shown, or instead may be a different number of one or more units with shared or distributed hardware and/or software.

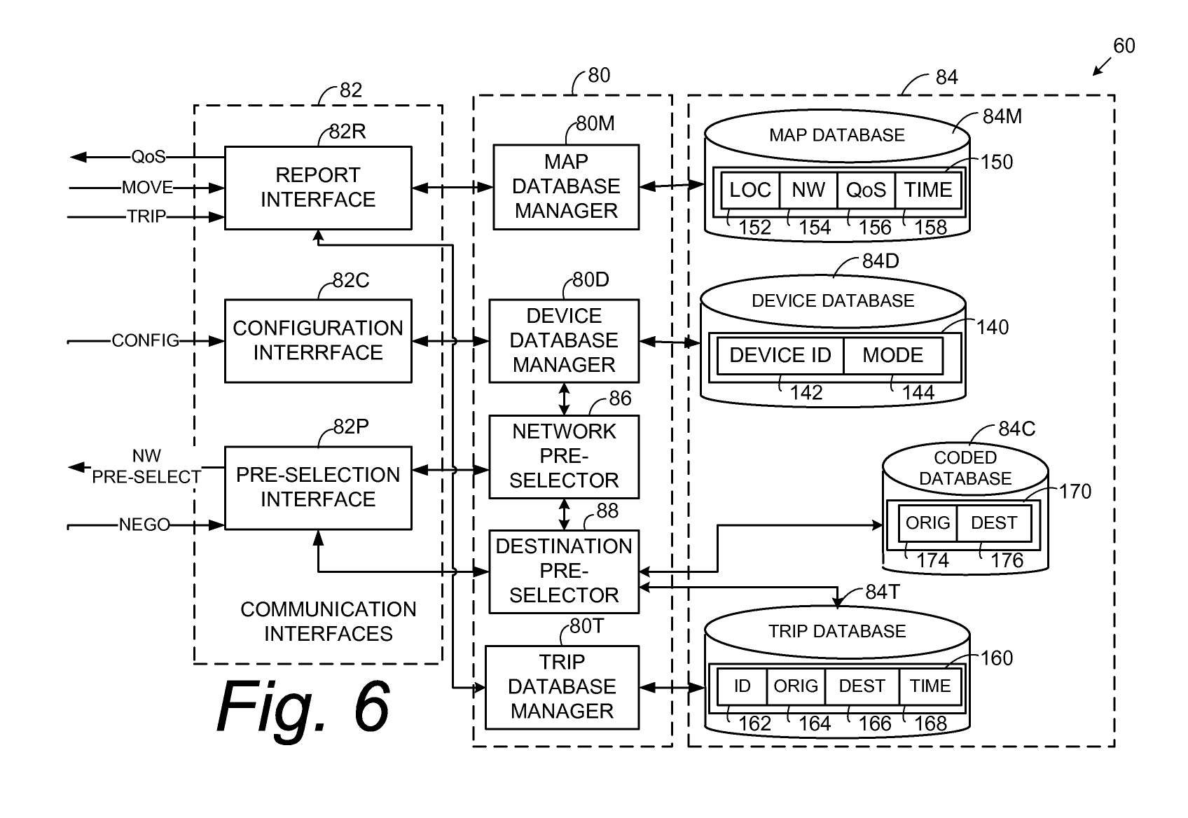

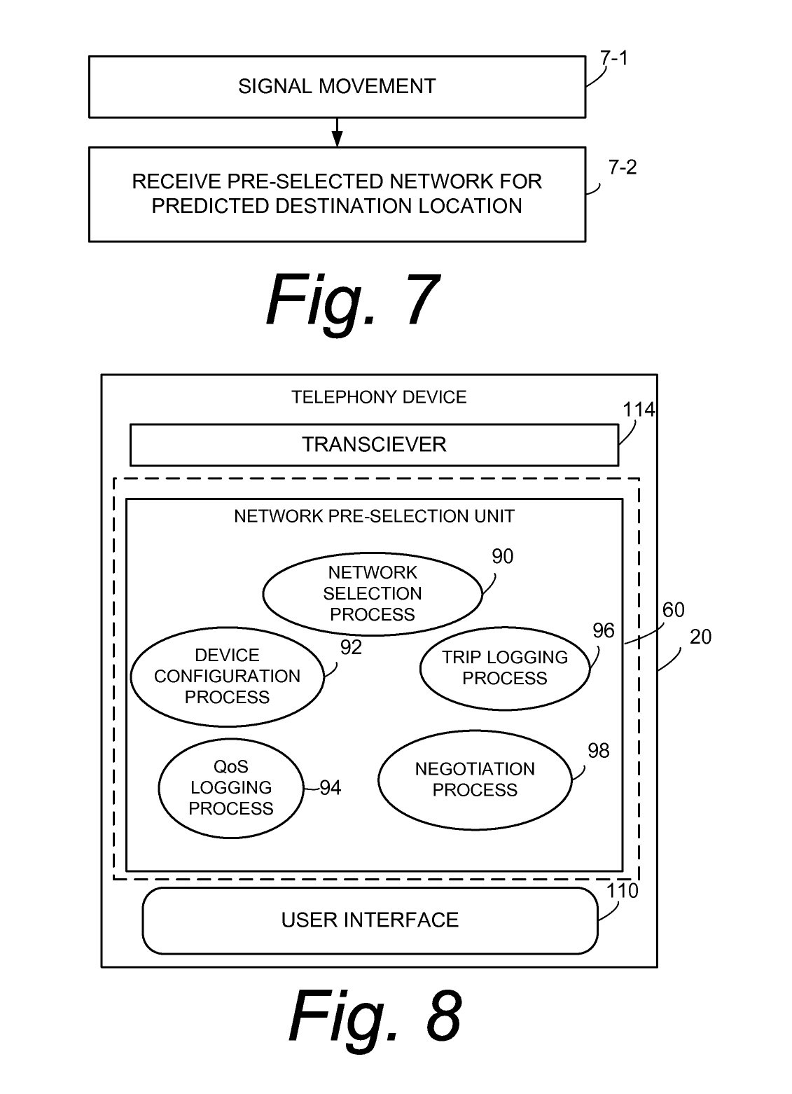

FIG. 7 shows various example basic acts or steps performed by network pre-selection unit 64 of wireless telephony device 30 according to an exemplary embodiment and mode when IP telephony system 20 serves as the network pre-selecting telephony equipment. Act 7-1 comprises the network pre-selection unit 64 signaling movement, e.g., providing an indication (“movement signal”) of actual or anticipated movement of wireless telephony device 30. The movement signal of act 7-1 is provided to IP telephony system 20, and particularly to network pre-selection processor 60. Act 7-2 comprises the network pre-selection unit 64 receiving, from network pre-selection processor 60 of IP telephony system 20, an indication of a pre-selected network for a pre-selected or predicted destination location of movement. In performing these acts, the network pre-selection unit 64 may execute various processes such as those shown by way of example in FIG. 8. As shown in FIG. 8, example processes performed by network pre-selection unit 64 include network selection process 90; device configuration process 92; quality of service (QoS) logging process 94; trip reporting process 96; and negotiation process 98. As explained herein, these processes work in conjunction with similarly named processes of network pre-selection processor 60, e.g., network selection process 90 works in conjunction with network selection process 70; device configuration process 92 works in conjunction with device configuration process 72; and so on.

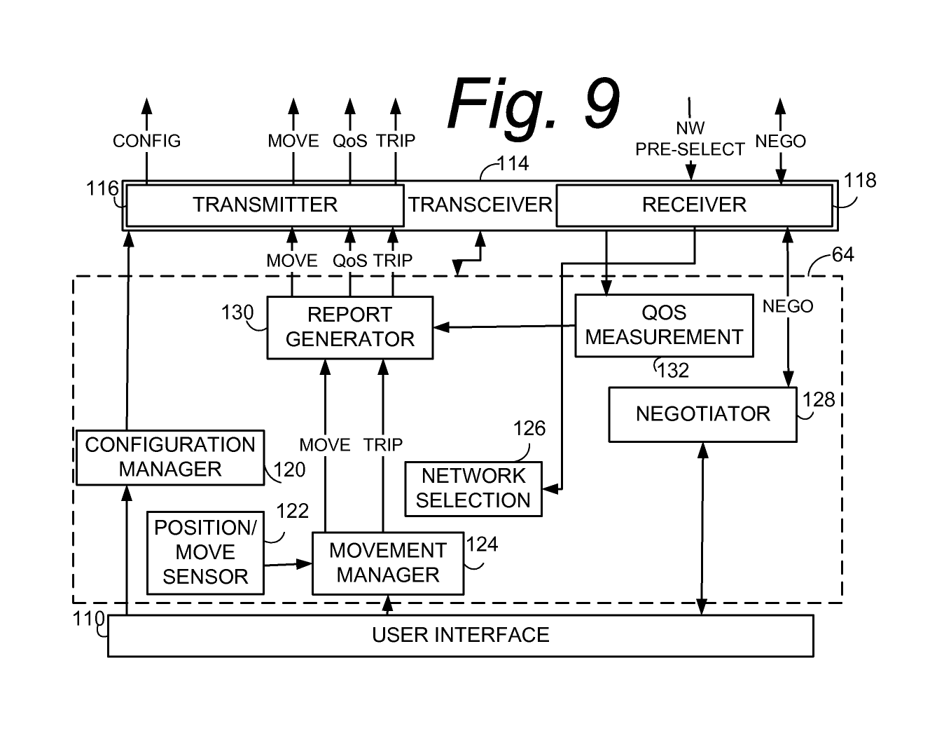

FIG. 9 shows non-limiting, non-exhaustive functionalities and units comprising a wireless telephony device when IP telephony system 20 (e.g., network pre-selection processor 60) serves as the network pre-selecting telephony equipment. FIG. 9 shows wireless telephony device 30 as comprising user interface(s) 110 and transceiver 114. The transceiver 114 in turn may comprise transmitter 116 and receiver 118. The network pre-selection unit 64 comprises configuration manager 120; position/move sensor 122; movement manager 124; network selection unit 126; negotiation unit (negotiator) 128; report generator 130; and quality of service (QoS) measurement unit 132.

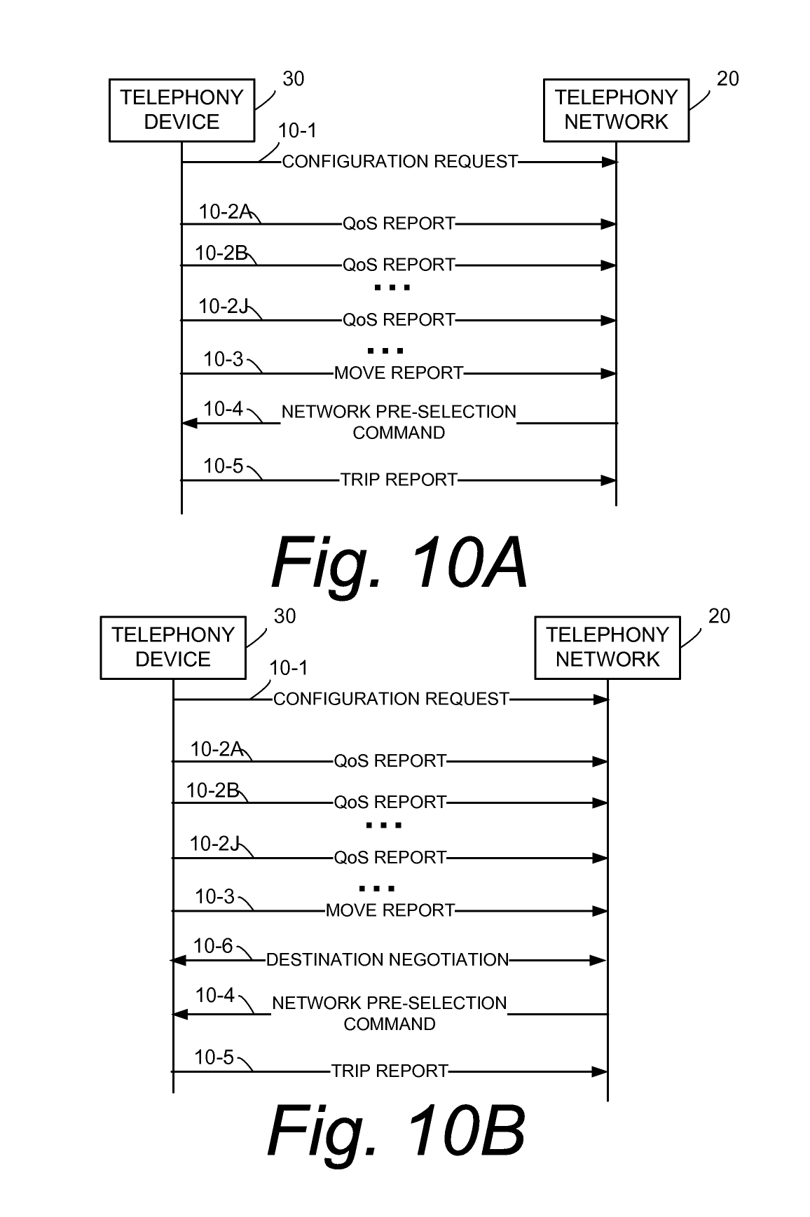

FIG. 10A is a signaling diagram illustrating various signals and/or messages transmitted between IP telephony system 20 and wireless telephony device 30 in conjunction with a network pre-selection procedure which is performed by cooperative execution of network pre-selection processor 60 and network pre-selection unit 64. The signaling of FIG. 10A is described with reference to the various processes performed by network pre-selection processor 60 and network pre-selection unit 64.

Act 10-1 of FIG. 10A shows wireless telephony device 30 device sending a configuration request message to IP telephony system 20. The configuration request message of act 10-1 may comprise information to enable network pre-selection processor 60 to better execute the network pre-selection procedure for the particular wireless telephony device 30. Among the information included in the configuration request message of act 10-1 may be, for example, a mode value (“mode”) for the wireless telephony device 30. Although not shown in FIG. 10, the telephony system 20 may acknowledge to telephony device 30 the receipt of the configuration request.

The mode value may indicate, for example, how a destination location for wireless telephony device 30, upon indication of a move, is to be determined. For example, the mode value may indicate that the user of wireless telephony device 30 wishes to negotiate (e.g., provide input, either explicit or otherwise) to network pre-selection processor 60 in the destination location determination. Alternatively, the mode value may indicate what type of destination selection logic is to be utilized by the network pre-selection processor 60 in the destination location determination. Example mode values may be personal historic, aggregate historic, or “hard coded”. “Personal historic” may be the most popular personal destination for a particular telephony device when beginning at a specified initial location. “Aggregative historic” may be the most popular personal destination for a group or all telephony devices when beginning at a specified initial location. “Hard coded” may be a destination which is preconfigured or otherwise supplied as the destination given a specified initial location.

The configuration request message of act 10-1 may include other information. For example, in an exemplary embodiment and mode the configuration request message of act 10-1 may comprise information that serves to block or preclude certain destinations from being predicted or pre-selected. For example, the configuration request message of act 10-1 may include a flag that indicates that certain destinations are to be considered as blocked; a number indicating how many or what range of destinations are to be blocked; and a listing of the identifiers of addresses of the block destinations. Blocking of destinations may occur when those blocked destinations require special access or reservation, and/or require payment of a fee, for example.

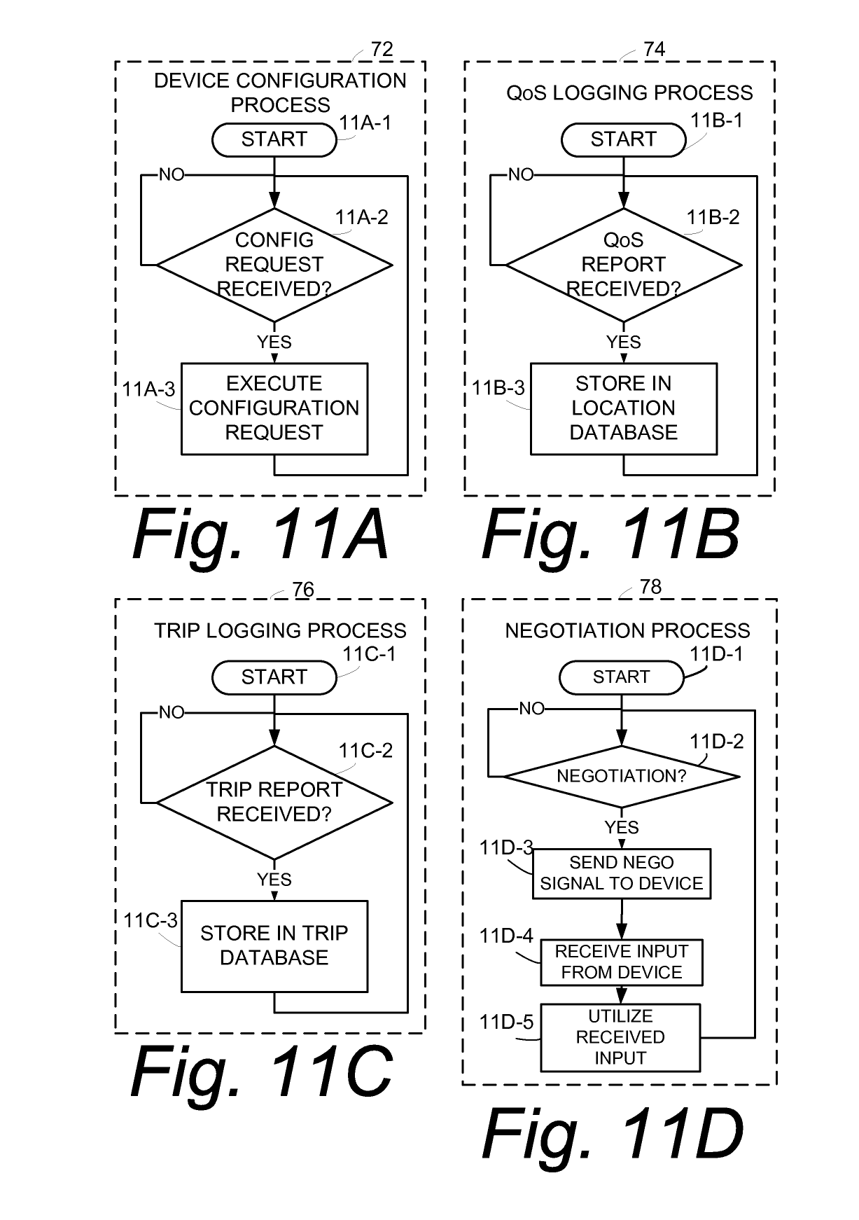

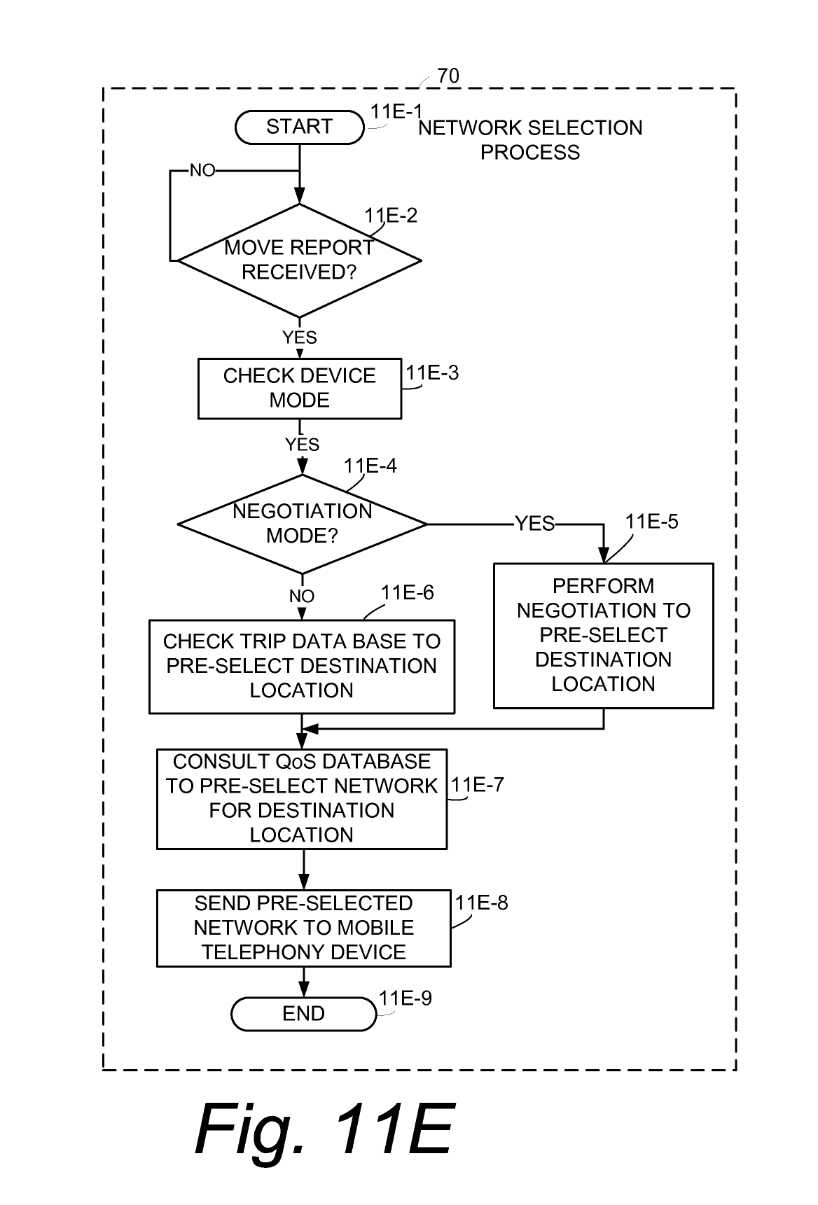

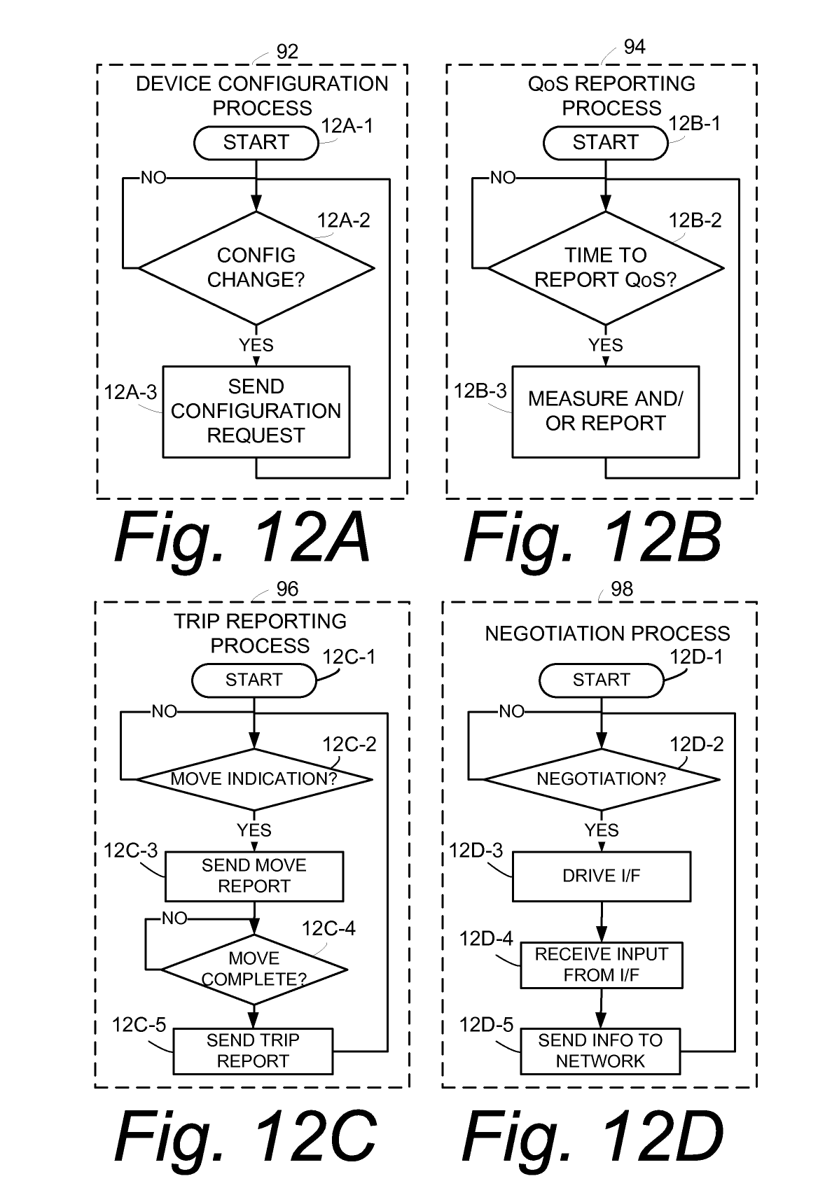

FIG. 11A shows basic example acts or steps performed by execution of the device configuration process 72 of network pre-selection processor 60; FIG. 12A shows basic example acts or steps performed by execution of the device configuration process 92 of network pre-selection unit 64. Both processes may be on-going, an instance of the processes for the particular telephony device 30 having been started (as reflected by acts 11A-1 and 12A-1, respectively) upon opening of the network pre-selection portion 64 of IP telephony application (app) 62 for that telephony device 30.

The user of telephony device 30 is given opportunity to initiate or change a configuration of IP telephony application (app) 62 that affects the network pre-selection procedure. Such opportunity may arise when, at strategic times, the IP telephony application (app) 62 drives user interface(s) 110 to prompt the user for entry of information pertinent to the network pre-selection procedure. Such pertinent information may include, for example, the “mode” value and the destination blocking information mentioned above. Alternatively the user, via appropriate menu displayed on user interface(s) 110, may select an appropriate screen for entry of the appropriate configuration information. Either action indicates, as act 12A-2, a configuration change. When a configuration change is detected at act 12A-2, a configuration request message such as that of act 10-1 of FIG. 10A is sent from telephony device 30 to telephony system 20. The configuration request message 10-1 is generated by configuration manager 120, in response to the user input on user interface(s) 110. The configuration request message may include any appropriate configuration parameter, such as the mode value mentioned above. The device configuration process 92 continues to periodically check for any further configuration change, as indicated by the negative branch of the decision of act 12A-2.

In the network pre-selection processor 60, act 11A-2 monitors for receipt of a configuration request message. The configuration request message, if successfully transmitted, is received by configuration interface 82C. Should a configuration request message be detected at act 11A-2, as act 11A-3 the configuration request of the configuration request message is executed. Such execution may involve, for example, storing the configuration parameter in device database 84D under control of device database manager 80D. FIG. 6 shows an example device database record 140 as comprising device identification field 142 and device mode field 144. In response to a configuration request message 10-1 that includes a mode value for a particular telephony device 30, the device database manager 80D stores the mode value in device mode field 144 for the device database record 140 that is associated with the telephony device 30 based on the device identification of the telephony device 30.

FIG. 10A further illustrates transmission of plural quality of service (QoS) reports 10-2A through 10-2J from telephony device 30 to telephony system 20. FIG. 11B shows basic example acts or steps performed by execution of QoS logging process 74 of network pre-selection processor 60; FIG. 12B shows basic example acts or steps performed by execution of quality of service (QoS) logging process 94 of network pre-selection unit 64. Both processes may be on-going, respective instances of the processes for the particular telephony device 30 having been started (as reflected by acts 11B-1 and 12B-2, respectively) upon start-up or opening of the network pre-selection portion 64 of IP telephony application (app) 62 for that telephony device 30.

Act 12B-2 of FIG. 12B comprises network pre-selection unit 64 checking to determine whether it is an appropriate time to send a quality of service report 10-2x. Such appropriate times may be either periodic or prompted by telephony system 20 or prompted by events or both. At an appropriate time, the quality of service (QoS) logging process 94 causes QoS measurement unit 132 to make a quality of service measurement (on downlink signals received by telephony device 30 over a wireless link or air interface) and causes report generator 130 to send the quality of service report 10-2x (respecting the quality of service over the wireless link) to telephony system 20. The quality of service report 10-2x may concern either a quality of service over a wireless link from a wireless access point 50 which transmits over an unlicensed frequency, or quality of service over a wireless link from a macro base station which transmits over a licensed frequency. Moreover, in at least some example embodiments and modes the quality of service report 10-2x may include quality of service measurements for plural networks,

The quality of service reports 10-2x may include information elements to express information such as, for example, an identifier of the telephony device 30 that sends the quality of service report; a location (LOC) at which the quality of service measurement is made; an identifier of the network(s) for which the quality of service measurement(s) was/were made; quality of service information (e.g., measured quality of service value) resulting from the quality of service measurement itself (Qos) for the respective measured network(s); and a time (e.g., time stamp) that the quality of service measurement was made. The quality of service information may be any appropriate quality of service indication, such as signal to interference and noise ratio (SINR), bit error rate (BER), packet loss, jitter, latency/delay, bandwidth, for example. The QoS measurement unit 132 is able to ascertain from downlink signals from the various networks for which it receives signals, not only the quality of service information, but also identification of the networks. For example, certain pilot signals from the networks include the network identifications and identifications of the particular access point or base station from which the pilot signal emanated. The position of the telephony device 30 at the time of the measurement may be obtained by position/move sensor 122 using, for example, Global Positioning System (GPS) information. The move/position sensor 122 is not limited, however, to GPS, as other position techniques (such as determining distances to access points of known locations) and movement detection techniques (such as accelerometer(s)) may be employed.

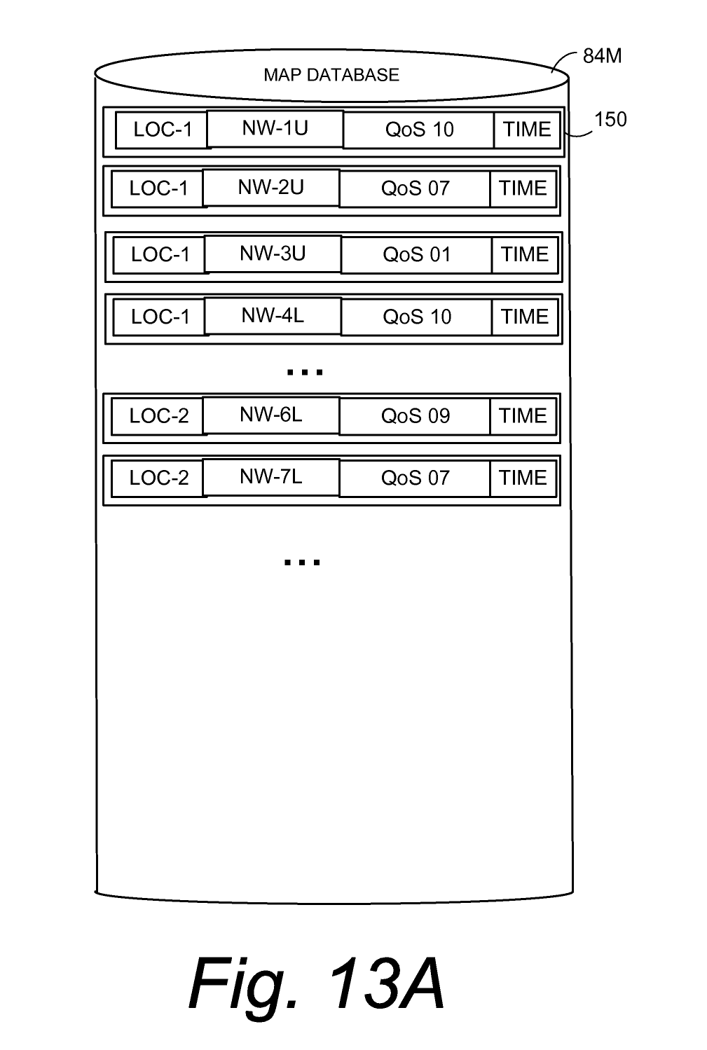

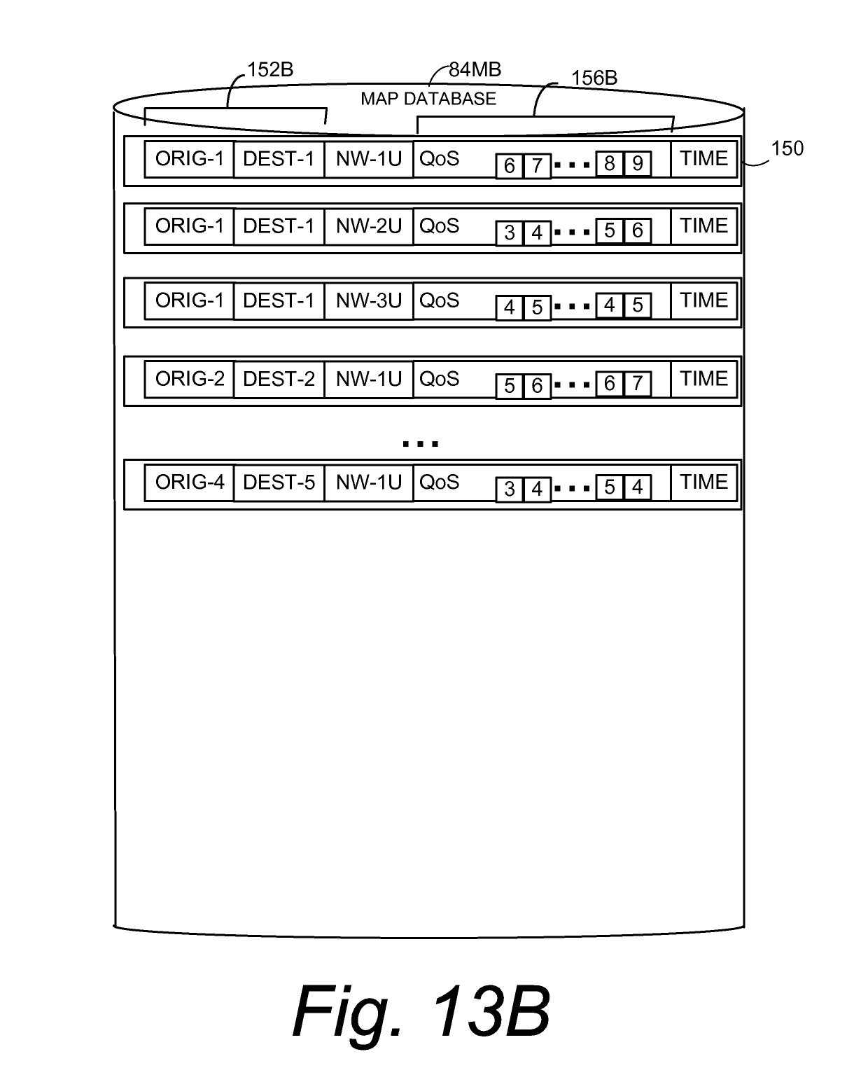

The quality of service report 10-2x is received by report interface 82R as act 11B-2. In response to receipt of service report 10-2x, as act 11B-3 map database manager 80M generates map database record map database record 150 in map database 84M for reach measured network. As shown in FIG. 6, the map database record 150 may include the following fields which corresponding to information elements, discussed above, in the quality of service reports 10-2x: location field 152; network field 154; quality of service (QoS) field 156; and time field 158. Thus, the map database manager 80M builds in map database 84M a collection of records 150, as illustrated by way of non-limiting example in FIG. 13A, so that map database 84M preferably includes numerous map database records 150 for each location (LOC). Thus, as understood from the foregoing as well as, e.g., FIG. 13A subsequently described, the map database 84M receives quality of service information reports for a pre-selected potential destination location respecting plural candidate wireless networks from plural reporting wireless telephony devices.

It should be appreciated that quality of service reports 10-2x may be generated at any time, including even before the configuration request message of act 10-1 and intermittent with or after other acts illustrated in FIG. 10A.

Act 10-3 of FIG. 10A shows transmission of a move report from telephony device 30 to telephony system 20. A move report is generated as part of trip reporting process 96 whenever an indication of movement of telephony device 30, either an actual movement or an anticipated movement, is detected. FIG. 11C shows basic example acts or steps performed by execution of the trip logging process 76 of network pre-selection processor 60; FIG. 12C shows basic example acts or steps performed by execution of the trip reporting process 96 of network pre-selection unit 64. Both processes may be on-going, an instance of the processes for the particular telephony device 30 having been started (as reflected by acts 11C-1 and 12C-1, respectively) upon opening of the network pre-selection portion 64 of IP telephony application (app) 62 for that telephony device 30.

Act 12C-2 of trip reporting process 96 comprises network pre-selection unit 64 receiving an indication of movement, either actual or anticipated, of telephony device 30. Actual movement may be detected by position/move sensor 122. Anticipated movement may be detected by the user making an entry on user interface(s) 110 that is indicative of the fact that the user intends to move, e.g., to travel. As a result of the sensed or otherwise indicated movement, movement manager 124 prompts generation and transmission of a move report (act 10-3 of FIG. 10A and act 12C-3 of FIG. 12C) by report generator 130. The move report indicates an identifier for the particular telephony device 30 making the move report, as well as the current location of that telephony device 30. If a move indication is not detected, the trip reporting process 96 continues to monitor by such a move indication as indicated by the negative branch from act 12C-2.

The move report of act 10-3 is received by report interface 82R of network pre-selection processor 60, and is handled by network selection process 70 of FIG. 11E. The network selection process 70 may be on-going, an instance of network selection process 70 for the particular telephony device 30 having been started (as reflected by act 11E-1) upon start-up or opening of the network pre-selection portion 64 of IP telephony application (app) 62 for telephony device 30 for that particular telephony device 30. A determination is made at act 11E-2 whether a move has been received by report interface 82R. If not, the check for a move report is periodically repeated as indicated by the negative branch of act 11E-2.

If a move report is detected as act 11E-2, as act 11E-3 the device database manager 80D is requested to check the mode value stored in device database record 140 for the move-reporting telephony device 30. In so doing, the device database manager 80D checks the device mode field 144 for the mode-reporting telephony device 30, having device identifier stored in device identification field 142. As previously indicated, such mode value may indicate that the user of wireless telephony device 30 wishes to negotiate (e.g., provide input, either explicit or otherwise) to network pre-selection processor 60 in the destination location determination, or alternatively the mode value may indicate what type of logic (e.g., either personal historic, aggregate historic, or hard coded) is to be utilized by the network pre-selection processor 60 in the destination location determination.

If the mode value obtain as act 11E-4 indicates that negotiation is to occur, the negotiation process 78 is begun in network pre-selection processor 60 and the negotiation process 98 is begun in network pre-selection unit 64. The negotiation process 78 and the negotiation process 98 are subsequent described with reference to FIG. 11D and FIG. 12D, respectively, as well as FIG. 10B.

If the mode value does not indicate a negotiation, as act 11E-6 the destination location predictor or pre-selector 88 consults an appropriate database in order to pre-select a potential destination location for the telephony device 30 which provided the move report. Depending on the mode value, the appropriate database may be either the trip database 84T or coded database 84C. In so doing the destination pre-selector 88 initiates act 4-1 of FIG. 4.

If the mode value does not indicate a hard coded output value, the destination pre-selector 88 consults trip database 84T. The trip database 84T includes trip report records 160 that are formatted to include reporting device field 162; trip origination location field 164; trip destination location field 166; and trip time field 168. The trip report records 160 are generated upon completion of a reported move, as below described in conjunction with act 10A-5.

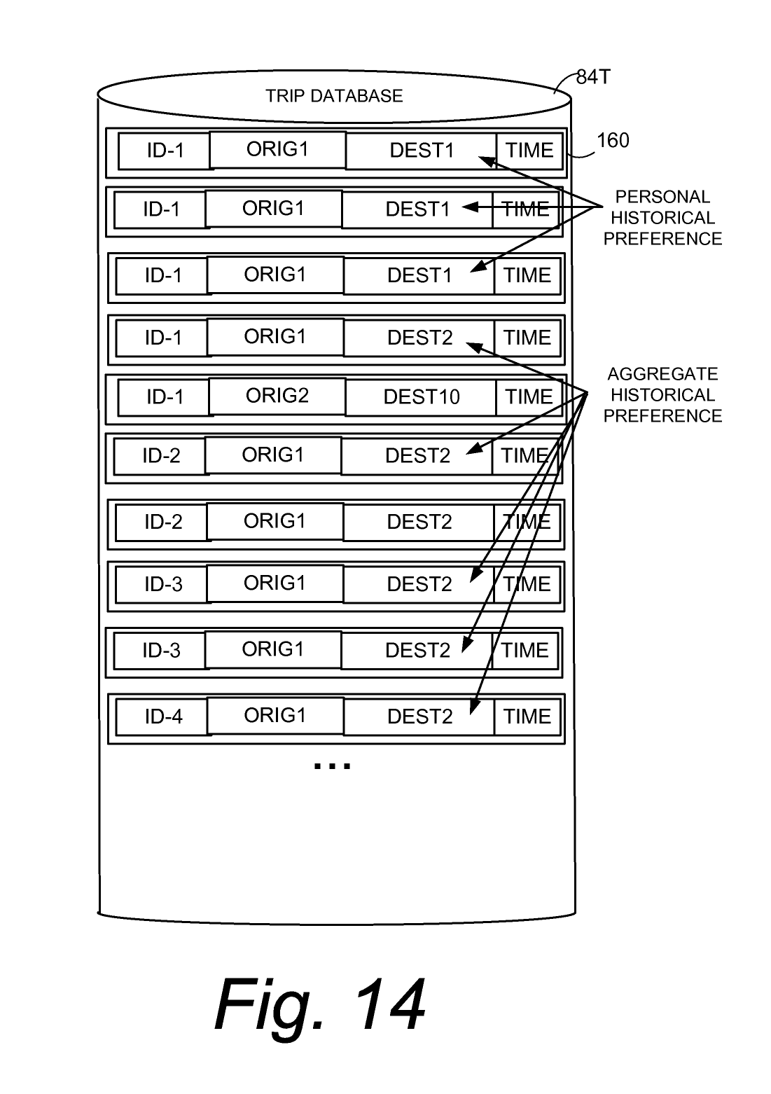

Prediction or selection of a pre-selected potential destination location by destination pre-selector 88 using the trip database 84T may also depend on, e.g., the mode value for the move-reporting telephony device 30 as stored in device mode field 144 of device database record 140, which was retrieved as act 11E-3. If, for example, the mode value indicated that the criteria for destination location pre-selection is personal historic behavior, the destination pre-selector 88 may analyze the trip report records 160 stored in trip database 84T to determine, for the particular move-reporting telephony device 30, the historically most popular destination location for that telephony device 30 when having the reported location as its origination location. For the example scenario of FIG. 14, for example, when the move-reporting telephony device 30 has identifier ID-1 and reports a location (original location) that corresponds to location ORIG1, a search of trip report records 160 for ID-1 shows that the historically most popular personal destination for telephony device ID-1 when beginning at location INIT1 is DEST1. On the other hand, if the mode value indicated that the criteria for destination location pre-selection is aggregate historic behavior, the destination pre-selector 88 may analyze the trip report records 160 stored in trip database 84T to determine, for all telephony devices that have previously reported trips, the historically most popular destination location for all such telephony devices when having the reported location as its origination location. For the example scenario of FIG. 14, for example, when the move-reporting telephony device 30 has identifier ID-1 and reports a location (original location) that corresponds to location ORIG1, a search of trip report records 160 for ID-1 shows that the most popular historical aggregate destination for all telephony devices when beginning at location INIT1 is instead DEST2.

As evident from the foregoing, in at least some exemplary embodiments and modes the destination pre-selector 88 is configured to dynamically pre-select the potential destination location of the movement based on historical activity of the wireless telephony device, either alone or in conjunction with other wireless telephony devices, in respect to an origination location of the movement. The “dynamic” aspect of the pre-selection occurs, e.g., in view of the fact that the trip database 84T which is used by the destination pre-selector 88 in making its pre-selection is eligible for continuing and automatic updates upon receipt of trip reports from the telephony device 30 and other wireless telephony devices, and thus is not stagnant or configured with an unchangeable or device-event-independent destination output of destination pre-selector 88 for a given origination location.

If the mode value indicates a “hard coded” output value, the destination pre-selector 88 consults coded database 84C. The coded database 84C includes hard coded records 170 that are formatted to include basically an origination location field 174 and a destination location field 176. The hard coded records 170 are preconfigured or otherwise supplied to coded database 84C and are not automatically updated by events such as receipt of trip report records or the like.

Thus, as act 4-1 the destination pre-selector 88 chooses a pre-selected destination location, either as above described with reference to logic applied to the trip database 84T or coded database 84C, or in conjunction with negotiation (as act 11E-5). As mentioned above, however, if certain destinations have been blocked or precluded from being predicted or pre-selected, those blocked destinations may not be chosen by destination pre-selector 88.

With the destination pre-selector 88 having pre-selected the destination location at either act 11E-5 or act 11E-6, as act 11E-7 the network pre-selector 86 pre-selects the network by consulting the map database 84M. In this regard, the destination pre-selector 88 searches the map database 84M for records that report quality of service measurements for the pre-selected destination location as chosen by destination pre-selector 88. In essence, the network pre-selector 86 searches through the map database records 150 for field location field 152 that is the same as the pre-selected destination location location, and chooses the most appropriate one of plural candidate networks (identified in network field 154) having the best quality of service measurement value as indicated by quality of service (QoS) field 156. For example, if the telephony system 20 uses access networks with unlicensed frequencies, the network pre-selector 86 will be configured to choose the unlicensed frequency network for the concerned location having the best quality of service value. If there are no access networks with unlicensed frequencies for the concerned location, then the network pre-selector 86 may choose a licensed network for the pre-selected network.

In an example scenario illustrated in FIG. 13A, if the pre-selected destination is location LOC-1, the network pre-selector 86 collects the map database records 150 which concern LOC-1, and then checks the values in the quality of service (QoS) field 156 for those records to determine the best quality of service value. The network pre-selector 86 may be configured to chose an unlicensed network if the telephony system 20 prefers to connect to telephony device 30 through unlicensed frequencies. Thus, in the example of FIG. 13A, the network pre-selector 86, when preferring unlicensed frequency network, may select network NW-1U which has quality of service value of 10 which, for purposes of illustration, is a higher quality of service value than other of the candidate networks shown in FIG. 13A. The network notation of FIG. 13A is such that “NW” means “network”, the “-x” refers to network number or name, and the “U” or “L” indicates unlicensed and licensed, respectively.

On the other hand, if the pre-selected destination/location were instead location LOC-2 as shown in FIG. 13A, the network pre-selector 86 would only have the choice of candidate network NW-6L and candidate network NW-7L, both of which are licensed networks. In that case, the network pre-selector 86 has no other choice than to choose a licensed network, and would most likely choose network NW-6L in view of its higher quality of service value.

In some situations the quality of service alone may not be the only criteria for making a pre-selection from among the candidate wireless networks. For example, cost of service may also be a factor. A cost factor may be involved, for example, when accessing gateways which connect to other networks, then there are routing considerations (e.g., least cost routing [LCR] which may encompass factors such as Answer-Seizure Ratio [ASR], Average Call Duration [ACD], etc. If desired, the network pre-selector 86 may include other rules or logic which, taken alone or in conjunction with quality of service, may be determinative of the pre-selected network choice.

Moreover, in some instances it is not just the quality of service at the destination location that is the basic criteria for network pre-selection. For example, in some situations the quality of service measurements at various locations along a path from an originating location to a destination location may be pertinent to network pre-selection. In such situations as that depicted in FIG. 13B, the location field 152B of map database record 150B in map database 84 MB may include both an origination location sub-field (ORIG) and a destination location sub-field (DEST). Moreover, the quality of service (QoS) field 156B may comprise quality of service (QoS) subfields wherein are stored quality of service values along different points of a path between the origination location (ORIG) and the destination location (DEST). The quality of service values may be obtained from the quality of service reports 10-2x (see FIG. 10A) as gathered from map database 84M, for example. Knowing the originating location and the destination location, map data base manager 80M may select certain of the locations known to be on a path between the origination location (ORIG) and the destination location (DEST); obtain from map database 84M the quality of service values for the points for respective networks; and insert those quality of service values into the subfields of quality of service (QoS) field 156B. With the map database 84 MB thus constructed, in an exemplary embodiment and mode the network pre-selector 86 may use both the current (e.g., origination) location of the telephony device 30 and the pre-selected destination location to determine a path defined by both locations as endpoints. Then network pre-selector 86 may then collect the map database records 150B that have the same endpoints, and select the pre-selected network based on consideration of more than one of the quality of service values stored in the quality of service subfields. For example, the network pre-selector 86 may pre-select the network based on a minimum threshold at plural or even all points along the path. Any other criteria or decisional logic may be applied to the plural quality of service values to pre-select a network.

As an example of the foregoing, FIG. 13B shows that there are three records for three respective networks concerning a path between originating location ORIG-1 and a destination location DEST-1. Of the three networks, network NW-1U has the best quality of service values by almost any criteria, whether average quality of service, all points along the path exceeding a minimum threshold, etc. Therefore, in the example of FIG. 13B, network NW-1U would most likely be the pre-selected network selected by network pre-selector 86.

After pre-selecting the network for the pre-selected destination/location, as act 10A-4 of FIG. 10A the telephony system 20, and particularly network pre-selector 86, sends a network pre-selection command to telephony device 30 through pre-selection interface 82P. The network pre-selection command of act 10A-4 is received by receiver 118 and forwarded to network selection unit 126.

In some instances the network of the pre-selected destination location may be the same network which is currently accessed by the telephony device 30, e.g., the same as the network accessed at the time of the beginning of the move. In such instances, a handover of the telephony device 30 may be performed from one access point (e.g., wireless access point) to another access point, but all within the same network. In other instances, the network of the pre-selected destination location may be the different than the network which is currently accessed by the telephony device 30. In such situations, the network selection unit 126 may prompt the sending of a location update command (to apprise the home location register 36 of the pre-selected network) and also provide the necessary information for the pre-selected network to transceiver 114 so that the transceiver 114 will tune to the proper frequencies for the pre-selected network.

The network pre-selection command of act 10A-4 was initially prompted by an indication of movement, actual or anticipated, of telephony device 30, and the pre-selected destination location was based on the original location of telephony device 30 at the time of the movement. It will be recalled that, as a result of the sensed or otherwise indicated movement, movement manager 124 prompted generation and transmission of a move report (act 10-3 of FIG. 10A and act 12C-3 of FIG. 12C) by report generator 130. Act 12C-4 of trip reporting process 96 involves movement manager 124 of telephony device 30 determining whether movement of the telephony device 30 is complete.

In some scenarios a move being complete may be determined by cessation of movement of the telephony device 30. The determination of whether movement has ceased, e.g., whether the trip is complete, may be aided or based on information acquired from move/position sensor 122.

In other scenarios in which the telephony device 30 may be on a long trip or the like, the trip logging process 96 may determine a move to be “complete” after the telephony device 30 has traveled longer than a predetermined distance or for longer than a predetermined time. In this way the trip logging process 96 may provide perhaps more appropriate short term information for the building of map database 84M and map database 84 MB. For example, the network pre-selection unit 64 may divide up a long trip into short segments so that more geographically proximate networks may be pre-selected along different segments of a longer trip.

If movement is not complete, the movement manager 124 continues to monitor for the trip being “complete”, as indicated by the negative branch from act 12C-4. When movement manager 124 determines that the move is complete, and thus a trip completed, as act 12C-5 the movement manager 124 prompts report generator 130 to send the trip report message of act 10-5 to telephony system 20. The trip report message includes an identifier of the particular telephony device 30 that provides the trip report, an origination location of the trip; a destination location of the trip; and a time at which the trip report was sent.

Act 11C-2 comprises the trip logging process 76 monitoring for the receipt of the trip report of act 10-5. If a trip report has not been received, the trip logging process 76 continues to check, e.g., periodically, for receipt of a trip report. When a trip report is received as determined by act 11C-2, as act 11C-3 the trip logging process 76 stores information from the trip report into a new trip report record 160 (illustrated in FIG. 6). The new trip report record 160 includes information to fill in the reporting device field 162; the trip origination location field 164; the trip destination location field 166; and trip time field 168. The trip report is thus useful in providing information to trip database 84T so that the trip database 84T may be used by destination pre-selector 88 in determining a pre-selected destination/location as above described in conjunction with act 11E-6 of network selection process 70 and FIG. 14, for example. Receipt of the trip report of act 10-5, as well as other messages discussed in conjunction with FIG. 10A, may involve an unillustrated acknowledgement message.

It was mentioned above that, as act 4-1, the destination pre-selector 88 may, when executing the network selection process 70, choose a pre-selected destination location in conjunction with negotiation (as act 11E-5 of FIG. 11E). Such negotiation is described with reference to negotiation process 78 and negotiation process 98, together with the exemplary embodiment and mode of FIG. 10B. FIG. 10B resembles FIG. 10A (with similarly numbered messages being essentially identical), but further includes a series of negotiation messages generally depicted as message 10-6 in FIG. 10B.

FIG. 11D shows basic example acts or steps performed by execution of the negotiation process 78 of network pre-selection processor 60; FIG. 12D shows basic example acts or steps performed by execution of the negotiation process 98 of network pre-selection unit 64. Both processes may be on-going, an instance of the processes for the particular telephony device 30 having been started (as reflected by acts 11D-1 and 12D-1, respectively) upon opening of the network pre-selection portion 64 of IP telephony application (app) 62 for that telephony device 30, or upon entry of a mode value that indicates that the telephony device 30 is to be involved in negotiation for pre-selection of the pre-selected destination/location.

Act 11D-2 of negotiation process 78 corresponds to act 11E-4 of network selection process 70, e.g., the network selection process 70 having checked the mode value for the telephony device 30. If the mode value (as stored in device mode field 144 of device database 84D for the particular telephony device 30) indicates that the telephony device 30 is to be involved in negotiation for pre-selection of the pre-selected destination/location, as act 11D-3 the destination pre-selector 88 prompts pre-selection interface 82P to begin the series of messages (depicted as act 10-6 in FIG. 10B). For example, the destination pre-selector 88 may prompt transmission of an introductory negotiation message to telephony device 30. Receipt of such introductory negotiation message is depicted as being detected by act 12D-2 of negotiation process 98 of FIG. 12D, and used to drive the user interface(s) 110 of telephony device 30 in order to elicit information from the user of telephony device 30 regarding the destination/location to be used as the introductory negotiation message.

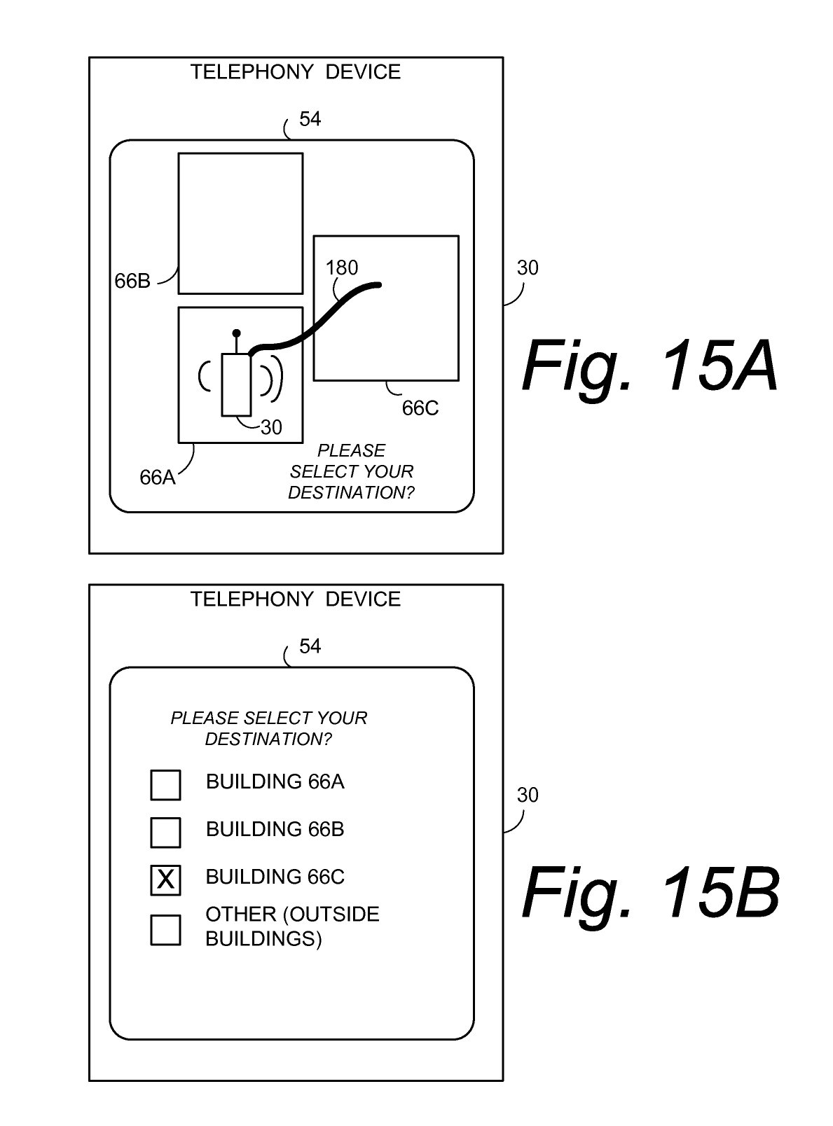

In the above regard, in an exemplary embodiment and mode the negotiation process 78 may request via negotiation process 98 that the user of the wireless telephony device provide an explicit indication of the potential destination location. There are numerous ways in which such explicit indication of the potential destination location may be requested and provided by the user. In one exemplary embodiment and mode, illustrated in FIG. 15A, the pre-selection processor 64 is configured to request the user of the wireless telephony device to mark a path or the potential destination location on a map displayed on the wireless telephony device (e.g., on input/output touchscreen/display screen 54). In the particular scenario pictured in FIG. 15A, the user has drawn or otherwise indicated on input/output touchscreen/display screen 54 a path 180 to building 66C. In another exemplary embodiment and mode illustrated in FIG. 15B, the pre-selection processor 64 is further configured to request a user of the wireless telephony device to select (e.g., on input/output touchscreen/display screen 54) the potential destination location from a plurality of location options displayed on the wireless telephony device. In the particular scenario picture in FIG. 15B, the input/output touchscreen/display screen 54 provides an interactive checklist of potential destination locations, e.g., building 66A, building 66B, building 66C, or “other” (e.g., outside buildings). In the particular scenario pictured in FIG. 15B, the user “checked” or otherwise selected building 66C on input/output touchscreen/display screen 54.

Act 12D-4 of the negotiation process 98 as shown in FIG. 12D comprises receiving input from user interface(s) 110 (e.g., from input/output touchscreen/display screen 54) regarding the user's explicit indication of the potential destination location. For example, in either the scenario of FIG. 15A or FIG. 15B the input may essentially indicate that building 66C is the potential destination location. In other example embodiment and modes the input may be in the form of geographical coordinates or other descriptors. As act 12D-5 the input obtained at act 12D-4 is sent to telephony system 20 in one of the messages included in the negotiation message series of act 10-6. The user's explicit indication of the potential destination location is received by pre-selection interface 82P and then provided to destination pre-selector 88, which then supplies the user's explicit indication of the potential destination location to network pre-selector 86. Then, as understood by act 11E-7 of the network selection process 70 of FIG. 11E, the user's explicit indication of the potential destination location is used to pre-select a network from map database 84M.

As mentioned above, in some exemplary embodiments and modes the telephonic equipment which performs the network pre-selection procedure may be a processor of the telephony device 30, e.g., may be a processor which implements or executes the network pre-selection unit. FIG. 16 shows an exemplary embodiment of telephony device 30 in which network selection unit 126 includes network pre-selection processor 60′. The network pre-selection processor 60′ is configured to enable the telephony device 30 to perform essentially the same network pre-selection procedure as previously described with reference to network pre-selection processor 60 of FIG. 6. In that regard, the network pre-selection processor 60′ comprises essentially the same types of processor(s), interfaces, and databases as previously described in conjunction with FIG. 6. In the FIG. 16 embodiment and mode, however, the information provided by acts such as act 10-1, act 10-2x, act 10-3, and act 10-5 of FIG. 10A, and act 10-6 of FIG. 10B, are utilized by network pre-selection processor 60′ in order to maintain essentially the same types of databases and make a pre-selected destination/location and network pre-selection in essentially the same manner as above described. A major difference, however, is that the network pre-selection processor 60′ does not communicate with telephony system 20 in the same manner, e.g., does not communicate in dependence upon telephony system 20 making a pre-selection. The telephony device 30 of FIG. 16 does receive quality of service reports such as act 10-2x and trip reports such as act 10-5 from other network elements, e.g., from either other relevant wireless telephony devices or from telephony system 20 in order to build its counterparts of the map database 84M and trip database 84T. In addition, the telephony device 30 continues of supply its quality of service reports (such as act 10-2x and trip reports such as act 10-5) to other network elements, e.g., to either other relevant wireless telephony devices or to telephony system 20, in order to allow those other network elements to build their counterparts of the map database 84M and trip database 84T.

Functions described herein, including the network pre-selection processor 60 of telephony system 20, as well as network pre-selection unit 64 and (for applicable embodiments) network pre-selection processor 60′, may, at least in some embodiments and modes, be performed by machine hardware 188. FIG. 17 shows an example of such machine hardware 188 as comprising one or more processors 190 (which could be processor(s) 60 of telephony system 20), program instruction memory 192; other memory 194 (e.g., RAM, cache, etc.); input/output interfaces 196; peripheral interfaces 198; support circuits 199; and busses 200 for communication between the aforementioned units.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 199 are coupled to the processors 190 for supporting the processor in a conventional manner. These circuits include cache, power supplies, clock circuits, input/output circuitry and subsystems, and the like.

Software routines such as software for network pre-selection processor 60 of IP telephony system 20 and software for IP telephony application 62 (including network pre-selection unit 64 and network pre-selection processor 60′ of FIG. 16) of wireless telephony device 30 may be computer program products which include coded instructions stored on non-transient medium and which are executed by processors of the IP telephony system 20 and wireless telephony device 30, respectively, for performing the acts described herein. For the machine hardware 188 of each of IP telephony system 20 and wireless telephony device 30 such software/computer program products may be stored on non-transient memory such as program instruction memory 192. Also, the software routines could also be stored remotely from the CPU, e.g., remotely from the processors. For example, the software could be resident on servers and memory devices that are located remotely from the CPU, but which are accessible to the CPU via a data network connection. Such software, when executed by processors 190, transforms the general purpose computer into a specific purpose computer that performs one or more functions of the IP telephony system 20 or telephony device 30. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the exemplary hardware recited above.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. Telephonic equipment comprising a pre-selection processor configured, upon receipt of an indication of actual or anticipated movement of a wireless telephony device, to pre-select a wireless network for wireless communication with the wireless telephony device for a pre-selected potential destination location of the movement.

2. The telephonic equipment of claim 1, wherein the pre-selection processor is configured to pre-select the wireless network by considering pre-selection criteria respecting plural candidate wireless networks for the predicted potential destination location.

3. The telephonic equipment of claim 2, wherein the pre-selection criteria comprises quality of service information respecting the plural candidate wireless networks for the predicted potential destination location.

4. The telephonic equipment of claim 3, wherein the pre-selection processor is configured to receive quality of service information reports respecting plural candidate wireless networks for the predicted potential destination location.

5. The telephonic equipment of claim 1, wherein the pre-selection processor is further configured to predict the potential destination location of the movement.

6. The telephonic equipment of claim 1, wherein the pre-selection processor is further configured to dynamically predict the potential destination location of the movement based on historical activity of the wireless telephony device in respect to an origination location of the movement.

7. The telephonic equipment of claim 1, wherein the pre-selection processor is further configured to dynamically predict the potential destination location of the movement based on historical activity of at least one or more of other wireless telephony devices in respect to an origination location of the movement.

8. The telephonic equipment of claim 1, wherein the pre-selection processor is further configured to predict the potential destination location in accordance with a hard coded predetermined association with an origination location of the movement.

9. The telephonic equipment of claim 1, wherein the pre-selection processor comprises a telephony system with which the wireless telephony device communicates.

10. The telephonic equipment of claim 9, wherein the pre-selection processor comprises an Internet-based telephony system.

11. The telephonic equipment of claim 9, wherein the pre-selection processor is further configured to receive negotiation information from the wireless telephony device to obtain the potential destination location.

12. The telephonic equipment of claim 9, wherein the pre-selection processor is further configured to request a user of the wireless telephony device for an explicit indication of the potential destination location.

13. The telephonic equipment of claim 12, wherein the pre-selection processor is further configured to request a user of the wireless telephony device to mark a path or the potential destination location on a map displayed on the wireless telephony device.

14. The telephonic equipment of claim 12, wherein the pre-selection processor is further configured to request a user of the wireless telephony device to select the potential destination location from a plurality of location options displayed on the wireless telephony device.

15. The telephonic equipment of claim 1, wherein the pre-selection processor comprises the wireless telephony device.

16. A wireless telephony device comprising a processor configured:
to provide an indication of actual or anticipated movement of the wireless telephony device to a telephony network;
to receive from the telephony network an indication of a suggested pre-selected wireless network for the wireless telephony device to access for wireless communications at a predicted potential destination location of the movement.

17. The wireless telephony device of claim 16, wherein the processor is further configured to send to the telephony network an origination location and an actual destination location associated with the movement.

18. The wireless telephony device of claim 16, wherein the processor is configured to pre-select the wireless network by considering pre-selection criteria for the predicted potential destination location respecting plural candidate wireless networks.

19. The wireless telephony device of claim 18, wherein the pre-selection criteria comprises quality of service information respecting the plural candidate wireless networks for the predicted potential destination location.

20. The wireless telephony device of claim 19, wherein the processor is configured to receive quality of service information reports for the predicted potential destination location respecting plural candidate wireless networks as gathered by plural reporting wireless telephony devices.

21. The wireless telephony device of claim 16, wherein the processor is further configured to predict the potential destination location of the movement.

22. The wireless telephony device of claim 16, wherein the processor is further configured to dynamically predict the potential destination location of the movement based on historical activity of the wireless telephony device in respect to an origination location of the movement.

23. The wireless telephony device of claim 16, wherein the processor is further configured to dynamically predict the potential destination location of the movement based on historical activity of at least one or more of other wireless telephony devices in respect to an origination location of the movement.

24. The wireless telephony device of claim 16, wherein the processor is further configured to predict the potential destination location in accordance with a hard coded predetermined association with an origination location of the movement.

25. The wireless telephony device of claim 16, wherein the processor is further configured to request a user of the wireless telephony device for an explicit indication of the potential destination location.

26. The telephonic equipment of claim 25, wherein the processor is further configured to request a user of the wireless telephony device to mark a path or the potential destination location on a map displayed on the wireless telephony device.

27. The telephonic equipment of claim 25, wherein the processor is further configured to request a user of the wireless telephony device to select the potential destination location from a plurality of location options displayed on the wireless telephony device.

28. A method in a communications network comprising:
obtaining an indication of actual or anticipated movement of a wireless telephony device;
upon receipt of the indication of the actual or the anticipated movement, pre-selecting a wireless network for wireless communication with the wireless telephony device for a predicted potential destination location of the movement.

29. The method of claim 28, further comprising:
the wireless telephony device providing the indication of actual or anticipated movement of the wireless telephony device to a telephony system;
the telephony system pre-selecting the wireless network for the wireless communication with the wireless telephony device for the predicted potential destination location of the movement; and
the wireless telephony device receiving from the telephony network an indication of the pre-selected wireless network for the wireless telephony device to access for wireless communications for the predicted potential destination location.

30. The method of claim 28, further comprising:
the wireless telephony device pre-selecting the wireless network for the wireless communication with the wireless telephony device for the predicted potential destination location of the movement.

31. The method of claim 28, further comprising pre-selecting the wireless network by considering pre-selection criteria for the predicted potential destination location respecting plural candidate wireless networks.

32. The method of claim 31, The wireless telephony device of claim 18, wherein the pre-selection criteria comprises quality of service information respecting the plural candidate wireless networks for the predicted potential destination location.

33. The method of claim 32, further comprising receiving quality of service information reports for the predicted potential destination location respecting plural candidate wireless networks from plural reporting wireless telephony devices.
